(19) United States
(12) Patent Application Publication
(10) Pub. No.: US 2003/0165015 A1
(43) Pub. Date: Sep. 4, 2003

(54) Coated contact lenses and methods for making same

(75) Inventor: Richard L. Jahnke, Bark River, MI (US)

Correspondence Address: STOUT, UXA, BUYAN & MULLINS LLP, 4 VENTURE, SUITE 300, IRVINE, CA, 92618, US

(73) Assignee: Ocular Sciences, Inc., Concord, CA

(21) Appl. No.: 10/306,716

(22) Filed: Nov. 27, 2002

Related U.S. Application Data
(60) Provisional application No. 60/336,832, filed on Dec. 5, 2001.

(51) Int. Cl. G02B 1/10

(52) U.S. Cl. 359/581; 359/900

(57) ABSTRACT

Coated contact lenses are produced by providing a lens and coating at least a portion of a surface of the lens derived from a binder component and an activation component. The binder component comprises a binding polymer component with at least one epoxy group, and preferably at least two epoxy groups, per polymer molecule. The activation component is capable of reacting with the binding polymer component to form a crosslinked polymer component. Methods of coating lenses and coating compositions are also provided.

### RELATED APPLICATION

This application claims the benefit of U.S. Provisional Application Serial No. 60/336,832, filed Dec. 5, 2001, the disclosure of which is incorporated in its entirety herein by reference.

### BACKGROUND OF THE INVENTION

The present invention relates to methods of coating lenses, coating compositions and coated lenses. More particularly, the invention relates to methods of coating contact lenses, coating compositions which are useful in such methods, and coated lenses, such as coated contact lenses, produced using such methods and/or such coating compositions.

Various methods have been developed and employed in the contact lens industry to coat contact lenses. Although some progress has been made in the field, there remain some serious deficiencies in these methods and the need for new lens coating methods.

For example, Loshaek U.S. Pat. No. 4,668,240 discloses a method for coating contact lenses. In brief, in accordance with this patent a colored contact lens is produced by a method which requires a contact lens constructed of a lens polymer. At least a portion of the surface of the lens is coated with a color coat comprising a coloring substance and a binding polymer. The lens polymer is then covalently bound to the binding polymer by the reaction of functional groups selected from at least one of —COOH, —OH and —NHR where R is hydrogen or alkyl with functional groups selected from at least one of —NCO and epoxy. In one embodiment, the lens polymer and the binding polymer have functional groups selected from at least one of —COOH, —OH and —NH—R and an additional compound is provided having at least two functional groups per molecule selected from at least one of —NCO and epoxy. The lens polymer and binding polymer can be directly covalently bound to each other by the reaction of functional groups on the lens polymer directly with functional groups on the binding polymer. Alternately, the lens polymer and binding polymer can be indirectly covalently bound to each other by the reaction of functional groups on the additional compound with functional groups or both the lens polymer and binding polymer. In any event, Loshaek U.S. Pat. No. 4,668,240 requires that the lens polymer and binding polymer are covalently bound to each other by the reaction of functional groups.

However, some hydrophilic contact lenses do not contain one or more of the functional groups —COOH, —OH, —NH—R, —NCO, or epoxy. Typical of such lenses are those disclosed in Loshaek et al U.S. Pat. No. 4,158,089 and Loshaek et al U.S. Pat. No. 4,182,802. The lenses disclosed in the latter patents are produced by polymerizing hydrophilic monomers, typically N-vinyl pyrrolidone, and hydrophobic monomers, typically alkyl esters of acrylic or methacrylic acid or styrene. The result is a hydrophilic lens that does not contain the functional groups —COOH, —OH, —NH—R, —NCO, or epoxy. Thus, the methods disclosed in Loshaek U.S. Pat. No. 4,668,240 are limited in use because not all contact lenses have the required functional groups.

In addition, involving the lens polymer in a reaction with the binding polymer or the additional compound, as disclosed by Loshaek U.S. Pat. No. 4,668,240, unfortunately creates the opportunity for functional groups from the binding polymer or the additional compound to diffuse into the lens polymer and react with functional groups in the lens polymer. Such reaction may change the nature of the lens polymer by, for example, lowering water content and expansion. By changing the nature and/or properties of the lens polymer, the functioning of the lens may be negatively impacted, for example, by altering oxygen permeability, curvature, optical power, fit and the like. In addition, the reaction between hydroxyl groups and diisocyanate, which is often used as the additional compound, is slow and requires lengthy heating at elevated temperatures to complete the reaction. This prolonged heating presents a serious manufacturing drawback.

Narducy et al in U.S. Pat. No. 4,963,159 discloses a substantially similar method to that of Loshaek U.S. Pat. No. 4,668,240 and suffers from the same deficiencies.

Bensky in U.S. Pat. No. 5,713,963 discloses the use of an urethane exchange reaction with the HEMA subunits of the coating polymer. This method is similar to the above-noted Loshaek and Narducy methods, and suffers from the same deficiencies. Furthermore, this method suffers an additional deficiency in that it requires additional heat to effect the urethane exchange reaction.

Su in U.S. Pat. No. 5,018,849 discloses a coating method which does not rely on the coating composition to provide adhesion of the coating to the lens. Instead, the method provides for a layer of lens polymer to be polymerized over an opaque layer, thereby laminating the opaque colorant within the lens, and then tinting the laminating layer with transparent dye. While this is an effective method for adhesion, it is a challenging manufacturing process. Furthermore, the method is very limited in providing colors to the coatings.

In light of the various deficiencies still present in the methods for coating contact lenses, there continues to be a need to have better methods for coating contact lenses.

### SUMMARY OF THE INVENTION

New methods of coating lenses, for example, contact lenses, coating compositions useful in such methods and coated lenses produced using such methods and/or such compositions have been discovered. The present invention provides substantial advantages and addresses one or more deficiencies of the prior art. For example, the present methods are straightforward and can be easily and effectively practiced in a commercial setting. The coating compositions of the present invention are easily produced and provide coated lenses having substantial benefits, for example, improved or enhanced oxygen permeability, wear comfort and/or color, and are easily and straightforwardly produced, and are colorable using a wide range of colors. Without wishing to limit the invention to any particular theory or mechanism, it is believed that at least some of the advantages provided for by this invention are at least partially due to the fact that the coating composition and/or the coating are substantially hydrophilic.

In accordance with the present invention, methods for coating a lens, for example, a contact lens such as a hydrophilic contact lens, comprise coating at least a portion of a surface of a lens or lens body with (i) a binder component comprising a polymer, or binding polymer, component having at least one epoxy group, preferably two or more epoxy groups, per molecule and (ii) an activation component, preferably a polyfunctional compound, that is a compound having at least two functional groups. The binder component and the activation component may be separately coated onto the lens surface. Preferably, a coating composition comprising both the binder component and the activation component is used in the present coating step. The present methods further comprise causing the activation component to react with the binder component, in particular the binding polymer component of the binder component, hereby forming a coating comprising a crosslinked polymer component. In one embodiment, the coating is substantially hydrophilic on the lens after it is cured or crosslinked.

Without wishing to limit the invention to any particular theory or mechanism of operation, it is believed that the activation component is caused to crosslink the binding polymer component by reacting with the epoxy groups located on or within the binding polymer component. Additionally, and advantageously the method of the present invention preferably does not crosslink the base lens polymer, that is the polymer included in the lens being coated, for example, because the activation component employed herein preferably is selected so as to not substantially react with the base lens polymer, even after being caused to react with the binder component, in particular the binding polymer component. In one very useful embodiment, there is no significant reaction between the activation component and the base lens polymer, so that, for example, the properties, such as oxygen permeability, hydrophilicity and the like, of the base lens polymer are not significantly affected by the reaction of the activation component with the binding polymer component located on a surface of the lens.

The binding polymer component or polymer component has at least one epoxy group, and preferably two or more epoxy groups, per molecule. In one embodiment, the binding polymer component may be made up of polymer molecules including one epoxy group and polymer molecules including two or more epoxy groups. The epoxy group or groups preferably are provided by an epoxy-containing monomeric component. For example, the epoxy group is part of a monomeric unit included in the binding polymer component. Preferably, the epoxy-containing monomeric component is polymerizable. For example, the epoxy-containing monomeric component may be an ethylenically unsaturated compound including an epoxy group. The epoxy group may be a part of an epoxy-containing compound.

Epoxy-containing monomeric components, for example, epoxy-containing monomers or compounds, include, for example and without limitation, glycidyl methacrylates, glycidyl acrylates, derivatives thereof and mixtures thereof. As used herein, the term “derivatives” refers to those materials which are sufficiently similar in chemical structure or make-up to the entity or entities of which they are identified as derivatives to function substantially similarly to such entity or entities in the present invention. For example, derivatives of glycidyl methacrylates and glycidyl acrylates include, without limitation, epoxy-containing esters and ethers of methacrylic acid and acrylic acid.

The epoxy groups of the binding polymer component are believed to react with the activation component, which is, for example and without limitation, one or more polyfunctional compounds, such as those selected from polyfunctional amines, polyfunctional acids, polyfunctional anhydrides, polyfunctional mercaptans, polyamides, melamine-formaldehyde compounds, urea-formaldehyde compounds, phenol-formaldehyde compounds, derivatives thereof, and the like and mixtures thereof, to form crosslinking bonds to or with the activation component. Additionally, the reaction between the epoxy groups and the activation component may produce hydroxyl groups, which aid in providing or retaining the hydrophilicity of the coating. In one embodiment, the hydrophilicity of the coating allows the coating to expand with the substrate or lens and improves oxygen permeability of the coating.

In one embodiment, in accordance with the present invention, the rate of reaction between the activation component and the epoxy groups is directly proportional to temperature. Advantageously, the epoxy groups react very slowly with the activation component at room temperature, which allows for a long working pot life. In one embodiment, the epoxy groups react relatively, or even very, quickly with the activation component at an elevated temperature, which allows for a rapid curing.

Preferably, in accordance with the present invention, the lens and the crosslinked polymer component of the coating do not have to be, and more preferably are not, chemically reacted with each other, for example, are not covalently bonded to each other, to bind or be effectively secured to each other. Thus, in one useful embodiment, the crosslinked polymer component is not covalently bonded to, or is substantially free of covalent bonds with, the lens, that is the base lens polymer. This advantageous feature of the present invention clearly distinguishes the present invention from Loshaek U.S. Pat. No. 4,668,240 which requires that the lens polymer be covalently bonded to the binding component.

Advantageously, in accordance with the invention, the coating is substantially hydrophilic.

The lens is constructed from or of a polymer. The lens polymer may be a homo-polymer or a co-polymer. Preferably, the lens polymer is a hydrophilic polymer. For example, and without limitation, the lens may be constructed from a hydrophilic polymer derived from at least one monomeric component selected from the group consisting of hydroxyalkyl methacrylates, such as hydroxyethyl methacrylate, methacrylic acid, N-vinylpyrrolidone, acrylamide, alkyl acrylamides, vinyl alcohol, silicon-containing monomers useful for polymerization into hydrophilic silicone polymers, siloxanes, silicon-containing acrylates, silicon-containing methacrylates, derivatives thereof and the like and mixtures thereof. The lens may be constructed of hydrophilic silicone polymeric compositions, for example, such materials commonly known as silicone hydrogels and the like and mixtures thereof. Many hydrophilic silicone polymeric compositions, e.g., silicone hydrogels, are conventional and well known in the art for use in lenses, such as contact lenses.

The lens, in particular the lens polymer, preferably is substantially devoid or substantially free of reactive or functional groups, for example, groups which react with the binding polymer component, the crosslinked polymer component or the activation component during the causing or crosslinking step of the present methods. For example, the lens preferably is substantially devoid or free of reactive or functional groups such as —COOH, —NH—R, NCO, epoxy groups and the like which react with the binding polymer component, the crosslinked polymer component or the activation component during the causing step of the present invention.

The polymer component or binding polymer component preferably comprises one or more polymers obtained from one or more hydrophilic monomers or monomeric components. In one embodiment, the binding polymer component is derived from at least one monomeric component selected from the group consisting of hydrophilic N-vinyl heterocyclic monomers; hydrophilic C₁ to C₆ vinyl ethers; hydrophilic C₁ to C₆ esters of acrylic acid; hydrophilic C₁ to C₆ esters of methacrylic acid; hydrophilic vinyl monomers; hydrophilic diene monomers; hydrophilic C₁ to C₆ alkoxy C₁ to C₆ alkyl esters of acrylic acid; hydrophilic C₁ to C₆ alkoxy C₁ to C₆ alkyl esters of methacrylic acid and the like and mixtures thereof. Preferably, the binding polymer component is derived from or includes at least one hydroxyalkyl, e.g., hydroxyethyl, methacrylate unit. In one embodiment, the binding polymer component is hydrophilic. For example, the binding polymer component comprises one or more hydrophilic polymers. The binding polymer component may include units derived from non-hydrophilic monomers or monomeric components in effective amounts, for example, to provide desired property enhancement. The amount of the non-hydrophilic monomers employed preferably is such as to have no substantial detrimental effect on the hydrophilicity of the final crosslinked polymer component.

In one embodiment, in accordance with the invention, one or more properties, for example, hydrophilicity, percent expansion, oxygen permeability and the like, of the crosslinked polymer component are substantially similar to that of the lens to which it coats or on which it is coated. In one embodiment, one or more properties of the crosslinked polymer component match almost exactly to that of the lens. Without wishing to limit the invention to any particular theory or mechanism, it is believed that matching of one or more properties between the crosslinked polymer component and the lens improves lens wearer comfort and avoids lens deformation.

In one very useful embodiment, in accordance with the invention, the coating composition further comprises a color component. For example, the coating composition may further comprise a color component having a metal oxide. The useful color component preferably is incorporated into a vehicle through established means known in the art. In one embodiment, the color components of use in this invention are insoluble in the vehicle and water.

Any material or combination of materials effectively useful as an activation component in the present invention may be employed. Of course, the activation component should have no undue or significant detrimental effect on the lens being coated or the wearing or wearer of the coated lens. The activation component preferably comprises an intermediate compound or a polyfunctional compound, that includes at least two functional groups per molecule, for example and without limitation, selected from the group consisting of polyfunctional amines, polyfunctional acids, anhydrides, polyfuntional mercaptans, polyamides, melamine-formaldehyde compounds, urea-formaldehyde compounds, phenol-formaldehyde compounds and mixtures thereof. In one embodiment, the intermediate compound is selected from polyamines, polyacids, anhydrides and mixtures thereof. In one useful embodiment, the intermediate compound is selected from the group consisting of a diamine, a diacid, an anhydride and mixtures thereof. Non-limiting examples of intermediate compounds include triethylene tetraamine, diethylene triamine, hexamethylene diamine, ethylene diamine and mixtures thereof. In one embodiment, the intermediate compounds have at least two —NH—R, wherein R is hydrogen or C₁ to C₈ alkyl.

Advantageously, the activation component includes no, or is free of, —NCO and epoxy groups, in particular reactive —NCO and epoxy groups which are effective to react with the binding polymer component and/or the lens polymer component, e.g., during the causing step of the present methods. This feature of the present invention is in direct contrast to Loshaek U.S. Pat. No. 4,668,240 which requires that when an additional compound is used that such additional compound have at least two groups selected from one or both of —NCO and epoxy.

Coating compositions useful in the present methods and coated lenses obtained using the present methods and/or coating compositions, as described herein, are included within the scope of the present invention.

Any feature or combination of features described herein are included within the scope of the present invention provided that the features included in any such combination are not mutually inconsistent as will be apparent from the context of this specification, and the knowledge of one of ordinary skill in the art.

Additional advantages and aspects of the present invention are apparent in the following detailed description and claims.

### DETAILED DESCRIPTION OF THE INVENTION

The present invention features a novel coating composition for coating a lens, methods for coating a lens, preferably a contact lens, and coated lenses, preferably coated contact lenses.

In one embodiment, the method comprises coating at least a portion of a surface of the lens or lens body comprising a lens polymer component with a coating composition, wherein the coating composition comprises (i) a binder component which comprises a polymer, or binding polymer, component and (ii) an activation component. The activation component is caused to react with the binder component, thereby forming a coating comprising a crosslinked polymer component, for example, on the surface of the lens.

The coating compositions of the present invention further provide for many additional advantages when applied onto a lens. For example, a clear coating composition may be layered onto a lens to form a clear coat or coating, that is a substantially optically clear coating. The clear coat may provide added or enhanced comfort to the lens wearer. Additionally, a colored coating composition, including a color component, in accordance with the present invention may be layered onto a contact lens to change or enhance the iris color of the wearer's eyes.

In one embodiment, the present invention relates to lenses, for example, contact lenses, capable of imparting an apparent color modification to the wearer's iris. The inventive lenses may be prepared with or without an optical prescription for correcting visual defects. The inventive lenses may contain an opaque color coat which can bring about a fundamental color change in the apparent color of the wearer's iris, for example from dark brown to light blue. Alternatively, the color coat may be transparent, in which case the apparent eye tint may be enhanced or the apparent color of light-colored eyes may be changed, for example, from light blue to green. Hence, as used throughout the present specification and claims, the term “colored lens” or “colored contact lens” is intended to mean a lens having either a transparent color coat or coating or an opaque color coat or coating or both, as well as a translucent color coat or coating.

Various polymers may be used to construct contact lenses suitable for use in accordance with this invention. Preferably, the lenses used in accordance with this invention are hydrophilic. Hydrophilic lenses may be constructed from large amounts of one or more monomeric unit components, i.e., monomeric components. For example, the monomeric unit component may comprise hydrophilic monomers which provide —OH, —COOH or —NCO(CH₂)₃ (e.g., pyrrolidone) functional groups. Examples of useful hydrophilic monomeric components include, without limitation, hydroxyalkyl methacrylates, such as hydroxyethyl methacrylate, methacrylic acid N-vinylpyrrolidone, acrylamide, alkyl acrylamides, vinyl alcohol, monomers, such as hydrophilic (meth)acrylates, useful for inclusion in hydrophilic silicone polymeric compositions, e.g., silicone hydrogels, silicon-containing monomers for polymerization into hydrophilic silicone polymers, siloxanes, such as organosiloxanes and the like and mixture thereof, silicon-containing acrylates, silicon-containing methacrylates, derivatives thereof, and the like, and mixtures thereof. Preferably, the lens is a hydrogel type-lens constructed from or of poly hydroxyethyl methacrylate (poly HEMA), silicone hydrogels, other suitable hydrogel-forming polymeric compositions and the like and mixtures thereof. Other non-limiting examples of lens polymers are described in Loshaek et al U.S. Pat. No. 4,405,773; Loshaek U.S. Pat. No. 4,668,240; Narducy et al U.S. Pat. No. 4,963,159; Frances et al U.S. Pat. No. 4,940,751; Fuhrman U.S. Pat. No. 4,638,025; and Deubzer et al U.S. Pat. No. 4,413,104, the disclosures of which are incorporated in their entireties herein by reference.

Polymerization and lens shaping are well known in the art. Any of the well known techniques may be used.

A binder component in accordance with the present invention may be in the form of a solution, gel, paste or the like. In a preferred embodiment, the binder component is a paste. Preferably, the binder component is such as to produce a final crosslinked coating which is hydrophilic, for example, a coating which absorbs water and swells with the lens.

The binder component comprises a polymer component or binding polymer component. In one embodiment, the binder component further comprises a color component. A binder component comprising a color component may provide for a color coating composition. Such a color coating composition may be referred to as an ink.

In one embodiment, the binder component comprises a polymer component, and not a color component. A binder component devoid or free of a color component may provide for a clear coating composition, and a clear, for example, substantially optically clear, coating on a lens, such as a contact lens.

The binding polymer component may comprise one type of binding polymer or a mixture of different binding polymers. In one embodiment, a binding polymer is made up of repeating monomeric units that are all the same, that is a homo-polymer. In one embodiment, a binding polymer is made up of repeating units of two or more different monomeric units, that is a co-polymer.

In one embodiment, the binding polymer component is derived from at least one monomeric component. Non-limiting examples of such monomeric components include, without limitation, hydrophilic N-vinyl heterocyclic monomers, such as N-vinyl-2-pyrrolidone; hydrophilic C₁ to C₆ vinyl ethers; hydrophilic C₁ to C₆ esters of acrylic and/or methacrylic acid, such as hydroxyethyl methacrylate; hydrophilic vinyl monomers; hydrophilic diene monomers; hydrophilic C₁ to C₆ alkoxy C₁ to C₆ alkyl esters of acrylic and/or methacrylic acid, such as ethoxyethyl methacrylate or methoxypropyl acrylate; and the like and mixtures thereof. Advantageously, the binding polymer is derived from at least one hydrophilic monomeric component, for example, selected from hydrophilic monomers noted in this paragraph. A preferred monomer for making the binding polymer component is hydroxyethyl methacrylate.

Preferably, the binding polymers have at least one pendant or projecting functional group, in particular at least one epoxy group, preferably two or more epoxy groups, per molecule. In one embodiment, the pendent groups originate from monomeric components. Preferably, the monomeric components include one or more epoxy groups. Like acrylic chemistry, epoxy chemistry is well developed and provides for a wide array of compounds containing epoxy groups. Non-limiting examples of epoxy-containing compounds include glycidyl methacrylate, glycidyl acrylate, derivatives thereof and the like and mixtures thereof.

In one embodiment, the pendant groups originate from a monomeric unit that is part of the polymeric backbone. For example, the epoxy functionality, that is the epoxy group or groups, may be introduced into the binding polymer component by incorporating a monomeric unit comprising an epoxy group into the polymeric backbone.

In another embodiment, the pendant groups originate from a monomeric unit which is attached to, for example covalently bonded to, another monomeric unit of the polymeric backbone. For example, the epoxy functionality may be introduced by incorporating an anhydride on the polymer chain and reacting the anhydride with a monomeric unit comprising an epoxy group, for example, a di-epoxy group. In addition, conventional and well known epoxy chemistry provides many other methods for introducing the epoxy functionality or epoxy groups into a molecule.

The binding polymer component preferably is prepared in a solution that initially contains the selected monomers, liquid medium (for example, a solvent for the monomers), a molecular weight modifier and a polymerization initiator in a reaction vessel. In one embodiment, the reaction vessel is chilled. In one embodiment, the reaction may be initiated with UV light for a duration of time sufficient to achieve a satisfactory polymerization level. For example, the reaction may be initiated with UV light at about 350 nm, although other wavelengths may be used. This produces an uncrosslinked polymer dissolved in a liquid medium, for example, a solvent. In a preferred embodiment, the molecular weight of the polymers is limited to maintain the viscosity of the solution in a usable range.

The molecular weight of the binding polymer component may be conveniently controlled by using a molecular weight modifier such as a chain transfer agent, as is well known in the art. Suitable chain transfer agents include, without limitation, 2-mercapto ethanol, 1-dodecyl mercaptan, other alkyl mercaptans, and the like and mixtures thereof. Use of extra liquid medium, for example a solvent, also contributes to molecular weight control.

Suitable polymerization initiators include, without limitation, free radial initiators such as benzoyl peroxide, t-butyl peroxybenzoate, t-butyl peroxide and, preferably, UV sensitive free radical initiators such as benzoyl methyl ether and 2,2-azobis(isobutyronitrile). However, the exact method of polymerizing the binding polymer component is not critical in accordance with the present invention.

In one embodiment, the binding polymer component is produced from a mixture of a copolymer having about 10 to about 25 parts hydroxyethyl methacrylate and about 1 part glycidyl methacrylate. In a preferred embodiment, the binding polymer comprises a copolymer having about 19 or about 20 to about 25 parts hydroxyethyl methacrylate and about 1 part glycidyl methacrylate.

The binding polymer components are preferably produced as solution polymers, and are preferably uncrosslinked. When using the preferred materials the reaction temperature is best kept low to prevent side reactions, for example, to the functional, e.g., hydroxyl, groups on the backbone polymer. It is therefore preferred to initiate the reaction with UV radiation while removing excess heat using a chilled bath. In one embodiment, the binder component comprises (by weight) about 20% to about 50% derived from 2-hydroxyethyl methacrylate, and about 0.25% to about 10% derived from an epoxy-containing monomeric component (e.g. comprising glycidyl methacrylate), and about 50% to about 80% liquid medium, for example, a solvent system.

An activation component is also introduced to the lens surface. The activation component may be introduced to the lens surface before, after or together with the application of the binder component. Preferably, the activation component is blended with the binder component to form a coating composition, which is then applied to the lens surface.

The activation component preferably comprises an intermediate compound or polyfunctional compound which is effective to crosslink the binding polymer component. Preferably, the intermediate compound or polyfunctional compound reacts with the epoxy-containing component located on or in the binding polymer component to achieve the crosslinking and provide a crosslinked polymer component.

In one embodiment, a single intermediate compound may react with at least two epoxy groups. For example, an intermediate compound or polyfunctional compound in accordance with this invention may comprise at least two reactive or functional sites which will allow it to react to or with at least two epoxy groups. The two epoxy groups advantageously are located on different binding polymer molecules and react with a single intermediate compound or polyfunctional compound. However, in a practical sense, it may be advantageous to employ an excess of polyfunctional compound, for example, an excess of amine groups, that is the mole ratio of functional groups, e.g., amine groups, from the polyfunctional compound to epoxy groups from the binding polymer component is greater than 1.

In one embodiment, the intermediate compound is selected from the group consisting of polyfunctional amines, polyfunctional acids, anhydrides polyfuntional mercaptans, polyamides, melamine-formaldehyde compounds, urea-formaldehyde compounds, phenol-formaldehyde compounds and mixtures thereof. A polyfunctional amine means an amine which may react with more than one other species, for example, two epoxy groups. In one embodiment, a polyfunctional amine is a primary amine. In one embodiment, a polyfunctional amine is a molecule having two or more amine groups. Similarly, a polyfunctional acid or an anhydride may each react with more than one other species, for example, each may react with two other epoxy groups. The intermediate compound or polyfunctional compound is advantageously selected from polyamines, polyacids, anhydrides and mixtures thereof. A polyamine or a polyacid may be a molecule having more than one amine group or more than one acid group, respectively. In one embodiment, the intermediate compound or polyfunctional compound is selected from the group consisting of a diamine, a diacid, an anhydride and mixtures thereof.

In one embodiment, the intermediate compound or polyfunctional compound is a molecule having one or more functional groups selected from the group consisting of amine group, an acid group, an anhydride group and mixtures thereof.

In one embodiment, the intermediate compound or polyfunctional compound comprises a polyfunctional amine containing 2 to about 10 carbon atoms per molecule.

The intermediate compounds or polyfunctional compounds may comprise reactive sites such as primary amines, secondary amines and tertiary amines. For example, an intermediate compound or polyfunctional compound may comprise a carbon backbone with at least two —NH—R groups projecting from it, wherein R is hydrogen or C₁ to C₈ alkyl. Non-limiting examples of intermediate compounds or polyfunctional compounds include triethylene tetraamine, diethylene triamine, hexamethylene diamine, ethylene diamine and mixtures thereof.

While amines are preferred as reactive sites for the intermediate compounds or polyfunctional compounds due to their reactivity, there are conditions when a slower reaction is desired, and in these cases other compounds, such as diacids, anhydrides and the like, are to be considered and used, if appropriate.

The activation component may be prepared as a solution. For example, an activation component solution may be prepared by combining (by weight) about 1% to about 25% intermediate compound or polyfunctional compound, e.g. triethylenetetramine, and about 80% to about 99% liquid medium, for example, a solvent system, e.g. isopropyl alcohol. Preferably, the activation component solution may be prepared by combining about 7% to about 13% intermediate compound or polyfunctional compound, e.g. triethylenetetramine, and about 85% to about 95% liquid medium, for example, a solvent system, e.g. isopropyl alcohol. More preferably, the activation component solution may be prepared by combining about 10% intermediate compound, e.g. triethylenetetramine, and about 90% liquid medium, for example, solvent system, e.g. isopropyl alcohol.

Without wishing to limit the invention to any particular theory or mechanism of operation, it is believed that the binder component adheres, that is physically, rather than chemically binds or is secured, to the lens surface by physically penetrating and interlocking with the polymer or polymers of the lens. This physical binding process may be initiated by, for example, an application of heat. Furthermore, it is believed that neither the binding polymer component of the binder component nor the activation component have to, and preferably neither the binding polymer component nor the activation component do, chemically react with the lens polymer surface for the coating and the lens to adhere to each other. In contrast, see, for example, Loshaek U.S. Pat. No. 4,668,240, which requires the binding polymer be covalently bonded to the lens polymer. For example, in one embodiment of the present invention, it is believed the hydrophilic lens polymer component does not react with the functional groups, e.g. epoxy groups, located on the binding polymer component or on the activation component for the coating and, in particular, the crosslinked polymer component, to effectively adhere to the lens surface.

Additionally, it is believed that the activation component allows for the crosslinked polymer component to effectively adhere to the lens surface after curing for a very modest or short time and/or a very modest or low temperature. In one embodiment, the activation component allows for curing at a lower temperature and for a shorter time than is required for coating methods using isocyanate and the like. For example, the step of curing according to the present invention may be for less than about 80 minutes and at less than about 50° C., preferably for less than about 60 minutes and at less than about 40° C. In one embodiment, the curing cycle ranges are short and hot (5 minutes at 90° C.). In one embodiment, the curing cycle ranges are long and cool (60 minutes at 40° C.). Such curing conditions effectively provide the desired crosslinking of the binding polymer component while not allowing or preventing any significant covalent reaction between the binding polymer component and the lens polymer component and between the activation component and the lens polymer component.

In one embodiment, the binder component and the activation component are mixed in a liquid medium, for example, a solvent system, to form a coating composition. In one embodiment, the coating composition further comprises additional monomers.

In one embodiment, the binder component and the activation component are mixed and are applied to the lens within about 360 minutes, preferably within about 240 minutes, and more preferably within about 120 minutes, after the binder component and the activation component are combined. In one embodiment, the binder component and the activation component are mixed and are applied to the lens in less than about 120 minutes, for example, the mixture may be applied immediately after they, that is the binder component and the activation component, are combined. In one embodiment, the binder component and the activation component are mixed and may still be effectively applied to the lens after about 360 minutes after being combined.

In one embodiment, the coating composition comprises about 10% to about 30% of the activation component and about 70% to about 90% of the binder component. Preferably, the coating composition comprises about 15% to about 25% of the activation component and about 75% to about 85% of the binder component. More preferably, the coating composition comprises about 20% of the activation component and about 80% of the binder component. The percentages set forth herein, unless noted otherwise, are based upon weight. With regard to the percentages set forth in this paragraph, such percentages are based on only the binder component and activation component present in the coating composition.

In one embodiment, a coating composition of the present invention is an optically clear coating composition. Such clear coating composition may comprise, for example, about 20% to about 50%, for example, about 35.7%, of a binding polymer component; about 40% to about 80% liquid medium, for example, about 14.9% of ethyl lactate and about 40.5% of pentanol; and about 5% to about 20%, for example, about 8.9%, of an activation component. The percentages are by weight.

Preferably, the present clear coating composition, when applied to the surface of a contact lens and cured, is effective to provide increased comfort to the lens wearer. For example, a tinted contact lens having a clear coating of the present invention is more comfortable to wear than a substantially identical tinted contact lens without the coating. In one embodiment, the coating has a thickness of less than about 20 microns, preferably less than about 10 microns.

In one embodiment, the clear coating composition may be coated onto the contact lens in any manner as to enhance lens wearer comfort. For example, the clear coating may be applied to the anterior convex side, the posterior concave side and/or both sides of a hydrophilic contact lens. Although a clear coating may be sandwiched between two color prints, in one useful embodiment the coating is applied as a top layer. Two spaced apart clear coatings of differing refractive indexes may be employed on a tinted contact lens to provide enhanced perception of depth and/or three dimensional effects to the tinted lens. This feature is described more fully in commonly assigned U.S. patent application Ser. No. (Attorney's Docket No. D-3023) filed on even date herewith, the disclosure of which is incorporated in its entirety herein by reference.

In one embodiment, the coating composition of the present invention is a color coating composition. For example, the binder component of the coating composition may further include a color component to provide for a color coating composition. The color component advantageously comprises pigments, for example, metal oxides, and/or other coloring substances. The color component may further include an appropriate and adequate amount of liquid medium, for example, a vehicle for the coloring substance, such as cyclohexanone, ethyl lactate and the like. For example, a color component comprising TiO₂ and cyclohexanone may be added to or combined with the binding polymer component to form a binder component. Preferably, this binder component is in the form of a paste.

In one embodiment, the color component provides for an opaque color on the lens. For example, a color component comprising titanium dioxide provides for an opaque white color. The degree of opaqueness may be varied depending on the pigments used.

In one embodiment, the color component provides for a transparent or translucent color on the lens. For example, a color component comprising phthalocyanine blue may provide for a translucent color on a lens.

The choice of pigments is quite flexible, since they need not necessarily contain functional groups. Preferred pigments include phthalocyanine blue (Pigment Blue 15, C.I. 74160) for a blue color; phthalocyanine green (Pigment Green 7, C.I. 74260) and chromium sesquioxide for a green color; various iron oxides for yellow, red, brown and black colors; titanium dioxide for white. Titanium dioxide is also used for increasing the opacity of other pigments.

In one embodiment, the binder component comprises about 47% to about 67% of binding polymer component and about 33% to about 53% of color component (based on the two components alone). Preferably, the binder component comprises about 50% to about 60% of binding polymer component and about 38% or 40% to about 48% or 50% of color component (based on the two components alone). More preferably, the binder component comprises about 57% of binding polymer component and about 43% of color component (based on the two components alone) . The binder component may have other ratios of binding polymer component to color component to achieve a certain color. See Example 2 below.

In one embodiment, the coating composition made in accordance with the present invention may be printed onto a wet lens.

Both the binder component and the activation component comprise a liquid medium, for example a solvent system. The liquid medium chosen depends on a variety of factors which are well known in the field of coating composition and paint formulation. For example, when a hydrogel type lens is used, the liquid medium should be compatible and provide some physical surface penetration for the coating to adhere properly. Preferred liquid medium systems include isopropyl alcohol, 3-pentanol, ethyl lactate and mixtures thereof. Other suitable liquid mediums include ethyl cellosolve, cyclopentanone, ethanol, t-butanol, acetone, other aliphatic, acyclic ketones and the like and mixtures thereof. In one embodiment, a liquid medium, for example, a solvent system, comprises a combination of liquid mediums. For example, a liquid medium (e.g., a solvent system) may comprise a combination of cyclopentanone and ethyl lactate. Also, ethyl lactate is a good co-solvent and under some circumstances water may be used as a co-solvent.

The following Table 1 shows the amount of ingredients used to form coating compositions in accordance with the invention. A coating composition comprises a binder component and an activation component. The binder component comprises a binding polymer component and a color component.

The percentages and the parts used herein are by weight.

TABLE 1
WEIGHT PERCENT OF COMPONENTS IN COATING COMPOSITIONS
(% are by weight)

| | | | MORE PREFERRED |
|---|---|---|---|
| | BROAD RANGE | PREFERRED RANGE | RANGE |
| INGREDIENT | (%) | (%) | (%) |
| Binder Component | | | |
| Binding polymer | About 5-70 | About 20-60 | About 35-45 |
| component (binding | | | |
| polymer with epoxy | | | |
| components, and | | | |
| liquid medium) | | | |
| Color Component | Functional (1) | About 0-60 | About 0-45 |
| (includes pigment | Amount | | |
| & liquid medium) | | | |
| Activation Component | Functional (1) | About 0.1-20 | About 10-25 |
| (includes crosslink | | | |
| compound and liquid | | | |
| medium) | | | |
| Additional Liquid | Functional (1) | About 0-50 | About 10-25 |
| Medium | | | |

(1) “Functional Amount” means the amount which one of ordinary skill in the art, would use to achieve a desired result.

The following non-limiting examples illustrate the invention. In the examples, the following abbreviations are used: HEMA is hydroxyethyl methacrylate; BME is benzoin methyl ether; GMA is glycidyl methacrylate; ME is mercapto ethanol; IPA is isopropyl alcohol; EL is ethyl lactate and TETA is triethylenetetramine.

### EXAMPLE 1

Method for Preparing a Binding Polymer Component

A mixture of 189.3 parts HEMA, 10 parts GMA (epoxy component), 0.3 part BME, and 0.42 part ME is made. This mixture is combined with 75 parts ethyl lactate and 225 parts isopropyl alcohol. The parts are by weight. The combination is placed in a flask and stirred, and nitrogen gas is bubbled through the stirred mixture. The flask is placed in an ice bath. Ultraviolet radiation is used to initiate the reaction. After about 3 hours the reacted combination is a thick clear solution of viscosity 40,000 cps. By weight percentage, the reacted combination polymer component comprises about 37.8% HEMA, about 2% GMA, about 0.06% BME, about 0.08% ME, about 15% EL and about 45% IPA.

Alternatively, the binding polymer component is made as follows: a mixture of 189 parts HEMA, 10 parts GMA (epoxy component), 0.34 part BME, and 0.1 part ME is made. This mixture is combined with 183.4 parts ethyl lactate and 333.4 parts isopropyl alcohol. The combination is placed in a flask and stirred, and nitrogen gas is bubbled through the stirred mixture. The flask is placed into an ice bath. Ultraviolet radiation is used to initiate the reaction. After about 3 hours the reacted combination is a thick clear solution of viscosity 1,500 cps. By percentage, the reacted combination comprises about 26.4% HEMA, about 1.4% GMA, about 0.05% BME, about 0.01% ME, about 25.6% EL and about 46.6% IPA.

Alternatively, the binding polymer component is made as follows: a mixture of 189 parts HEMA, 10 parts GMA (epoxy component), 0.3 parts BMD, and 0.64 parts ME is made. This mixture is combined with 75 parts EL and 225 parts IPA. The combination is placed in a flask.

After three hours the reacted combination is a thick clear solution of viscosity 15000 cps. By weight percentages the reacted combination polymer component comprises about 37.8% HEMA, about 2% GMA, about 0.06% BME, about 0.13% EL and about 45% IPA.

The “parts” are in reference to weight units. Percentages are also in reference to weight units. Each of the parts or percentages identified above may be varied by about 0.5 times to about 3 times to form a binding polymer component of the present invention.

TABLE 2
shows the three binding polymer component
formulations. Percentages are by weight.

| Formulation | Ingredient | Weight % |
|---|---|---|
| 1A | HEMA | 37.86 |
| | GMA | 2 |
| | IPA | 45 |
| | EL | 15 |
| | BME | 0.06 |
| | ME | 0.08 |
| 1B | HEMA | 26.39 |
| | GMA | 1.4 |
| | IPA | 46.55 |
| | EL | 25.61 |
| | BME | 0.05 |
| | ME | 0.01 |
| 1C | HEMA | 37.8 |
| | GMA | 2 |
| | IPA | 45 |
| | EL | 15 |
| | BME | 0.06 |
| | ME | 0.13 |

### EXAMPLE 2

Preparation of a Binder Component

A binder component includes a binding polymer component. A binder component often further comprises a color component. For example, a binding polymer component of Example 1 may be combined with a color component to form a binder component. In one embodiment, about one part of color component is combined with about 1 part binding polymer component to form a binder component. In one embodiment, about 43 parts of color component are combined with about 57 parts of binding polymer component.

The color component may be prepared by dispersing a pigment (e.g., titanium dioxide and the like) in a suitable liquid medium (e.g., ethyl lactate, cyclohexanone and the like). Color components comprising other pigments and/or other liquid media may be used. The color components may be prepared by mixing the pigment or pigments with the liquid medium or media at conditions, for example, with stirring and/or agitation and the like, effective to form a suitable dispersion.

For example, the color component may be produced by weighing the pigment and liquid medium into a flask and mixing using a high speed blender, for example a Dispermat® blending sold by BYK Gardner (Caframo), and blending until an appropriately fine particle size is reached. Pigment particle size can be measured using a fineness of grind gauge. A reading of no particles greater than about 20 micron is advantageous.

Table 2.1 below gives examples of colorant components including ethyl lactate (dispersing liquid) and various pigments. The percentages are by weight.

TABLE 2.1

| | | | Percent of |
|---|---|---|---|
| | | Percent of | Dispersing |
| Formulation | Color | Pigment | Liquid |
| 2A | Phthalocyanine Blue | 30 | 70 |
| 2B | Phthalocyanine Green | 30 | 70 |
| 2C | Iron Oxide Red | 50 | 50 |
| 2D | Iron Oxide Black | 50 | 50 |
| 2E | Iron Oxide Yellow | 39 | 61 |
| 2F | Chromium Oxide Green | 50 | 50 |
| 2G | Titanium Dioxide White | 50 | 50 |
| 2H | Carbazole Violet | 50 | 50 |

Alternatively, the same liquid medium/pigment mixtures can be charged to a ball mill and processed to colorant components having similar fineness of grind properties.

These pure pigment mixtures can be used directly as color components or, preferably, two or more of such mixtures can be mixed together, in varying amounts, to produce the desired color component. Non-limiting examples of these mixtures are given in Table 2.2 below. These mixtures could be produced directly by blending or milling the pigments with a liquid medium, but the ability to form a desired color from a plurality of individual pigment/liquid medium mixtures gives a more versatile system.

TABLE 2.2
Color components from pure pigment
mixtures. The parts are by weight.

| | Pigment | | |
|---|---|---|---|
| Formulation | Mixture | Parts | Color |
| 2I | 2A | 43.2 | Blue |
| | 2G | 56.8 | |
| 2J | 2A | 5.2 | Green |
| | 2C | 10 | |
| | 2E | 8.9 | |
| | 2F | 66.4 | |
| | 2G | 9.7 | |
| 2K | 2C | 11.9 | Brown |
| | 2D | 7.5 | |
| | 2E | 57.9 | |
| | 2G | 22.8 | |

### EXAMPLE 3

Preparation of Coating Composition

A coating composition may be prepared by blending together a binder component and an activation component. The binder component comprises a binding polymer component and a color component. Table 3.1 lists some non-limiting examples of binding polymer component and color component mixtures which form binder components. These mixtures may be made by simply weighing the components and mixing them mechanically. The parts are by weight.

TABLE 3.1
Binder components.

| | |
|---|---|
| Binding | |
| Polymer | Color |
| component | component |

| Composition | Type | Parts | Type | Parts |
|---|---|---|---|---|
| 3A1 | 1A | 9 | 2I | 6 |
| 3A2 | 1C | 9 | 2I | 6 |
| 3B1 | 1A | 9 | 2J | 6 |
| 3B2 | 1C | 9 | 2J | 6 |
| 3C1 | 1A | 9 | 2K | 6 |
| 3C2 | 1C | 9 | 2K | 6 |

The activation component comprises a compound capable of reacting to the reactive sites on the binding polymer component. The activation component may also comprise a liquid medium or vehicle. Several non-limiting activation component mixtures are given in Table 3.2 below. The parts are by weight.

TABLE 3.2
Activation component compositions. The parts
are by weight.

| | Parts of | Parts of Ethyl |
|---|---|---|
| Composition | TETA | Lactate |
| 3D | 1 | 9 |
| 3E | 0 | 1 |

A coating composition is produced with appropriate combinations of binder component and activation component. Additional materials may be added to give the binder component (or coating composition) the properties needed for a particular application. Several non-limiting examples of coating compositions are given in Table 3.3 below.

TABLE 3.3
Coating compositions. The parts are by weight.

| | | Activa- | | | | | |
|---|---|---|---|---|---|---|---|
| | | tion | | Binder | | Other | |
| Ink | Color | Component | Parts | Component | Parts | materials | Parts |
| 3F1 | Blue | 3D | 3.5 | 3A1 | 15 | 2 pentanol | 5 |
| 3F2 | Blue | 3D | 3.5 | 3A2 | 15 | 2 pentanol | 5 |
| 3G1 | Green | 3D | 3.5 | 3B1 | 15 | 2 pentanol | S |
| 3G2 | Green | 3D | 3.5 | 3B2 | 15 | 2 pentanol | 5 |
| 3H1 | Brown | 3D | 3.5 | 3C1 | 15 | 2 pentanol | 5 |
| 3H2 | Brown | 3D | 3.5 | 3C2 | 15 | 2 pentanol | 5 |
| 3I | Blue | 3E | 3.5 | 3A1 | 15 | 2 pentanol | 5 |
| 3J | Green | 3E | 3.5 | 3B1 | 15 | 2 pentanol | 5 |

### EXAMPLE 4

Method of Coating a Lens

The method for coating a lens includes providing a lens and coating at least a portion of a surface of the lens with a coating composition. The coating composition comprises a binder component and an activation component. The binder component comprises a binding polymer component which has one or more epoxy groups, and the activation component comprises a polyfunctional compound which is effective to react with the binding polymer component.

In one embodiment, the coating composition comprises about 70% to about 90% binder component and about 10% to about 30% activation component. The percentages are by weight. Preferably, the coating composition comprises about 80% binder component and about 20% activation component. The binder component preferably comprises about 45% to about 75% binding polymer component and about 30% to about 55% color component.

In one embodiment, the binding polymer component preferably comprises about 35% to about 45% 2-hydroxyethyl methacrylate, about 1% to about 10% glycidyl methacrylate, about 0% to about 0.2% benzoin methyl ether and about 50% to about 60% ethyl lactate. In another embodiment, the binding polymer component comprises about 40% 2-hydroxyethyl methacrylate, about 4% glycidyl methacrylate, about 0.15% benzoin methyl ether and about 56% ethyl lactate.

In one embodiment, the activation component comprises about 1% to about 30% triethylenetetramine and about 70% to about 99% isopropyl alcohol. A useful activation component comprises about 10% triethylenetetramine and about 90% isopropyl alcohol.

### EXAMPLE 5

Printing and Testing of Colored Lenses

The coating compositions in Example 3 are suitable for pad printing. Coating compositions in 3F and 3G are printed via pad printing onto a dry Ocufilcon contact lenses. The Ocufilcon polymer is substantially polyHEMA. It produces a contact lens having about 55% by weight water content upon hydration.

The printed lenses are divided into two groups. One is cured after printing at about 90° C. for about 5 minutes. The second group is cured after printing at about 40° C. for about 1 hour. All the lenses are then hydrated to their final state, and adhesions of the print to the lenses are tested.

Several adhesion tests are available. For example, a rub test involves simply rubbing the lens between the forefinger and the palm of the hand in a way that all contact lens wearers are taught to clean their lenses. A lens is rubbed for about 10 seconds on one surface, and is turned over and is rubbed again on the other side for about another 10 seconds. The lens is visually inspected for any colorant removal. The lens passes only if there is no colorant removed.

A more rigorous test is the “methanol test”. This test involves placing the hydrated test lens into methyl alcohol in an ultrasonic bath for one minute. The lens is then removed and allowed to re-equilibrate in saline. It is then given the rub test described above. The evaluation for colorant removal is the same.

Various coating compositions are applied onto the lenses and are evaluated by the rub test and the methanol test. The results are shown on Table 4. The coating compositions of 3F and 3G comprised an activation component and all passed. The coating compositions of 3I and 3J include no activation component and all failed. This is substantial evidence that the binding polymer component does not significantly covalently bond to the poly HEMA lens polymer since the colorant is substantially removed from the lens even in the less rigorous rub test.

TABLE 4
Adhesion testing results

| Ink | Cure Cycle | Rub Results | Methanol Results |
|---|---|---|---|
| 3F1 | 90, 5 minutes | All Pass | All Pass |
| 3F1 | 40, 60 minutes | All Pass | All Pass |
| 3F2 | 90, 5 minutes | All Pass | |
| 3G1 | 90, 5 minutes | All Pass | All Pass |
| 3G1 | 40, 60 minutes | All Pass | All Pass |
| 3G2 | 90, 5 minutes | All Pass | |
| 3I | 90, 5 minutes | All Fail | All Fail |
| 3I | 40, 60 minutes | All Fail | All Fail |
| 3J | 90, 5 minutes | All Fail | All Fail |
| 3J | 40, 60 minutes | All Fail | All Fail |

### EXAMPLE 6

Printing Wet Lenses

Hydrated 55% water content Ocufilcon contact lenses are mounted onto spherical plastic mounts. The lenses are printed with either coating composition 3H1 or 3H2 (each coating composition is printed onto at least one lens), and are cured for about 2 hours at about 40 degrees C. The lenses are allowed to re-equilibrate in saline, and are then subjected to the methanol adhesion test. All passed. Substantially no colorant is removed from the lenses.

### EXAMPLE 7

Printing on Lenses Having No Reactive Sites

The coating composition formulation 3H1 or 3H2 is printed onto dry Surfilcon contact lenses, which are 73% water content (when hydrated) MMA (methyl methacrylate)/n-vinyl pyrrolidone polymer-based contact lenses having no reactive —OH, —COOH, or —NH sites. Each coating composition is printed onto at least one lens. The lenses are cured for about 10 minutes at about 90° C. After the lenses are hydrated, they are subjected to a methanol adhesion test. All passed. Substantially no colorant was removed. The fact that the contact lenses had no reactive sites and the coating composition was not removed showed that effective and secure coating is achieved without the coating composition being chemically bound, e.g., covalently bound, to the lenses.

Various references and patents have been cited herein. These references and patents are incorporated in their entireties herein by reference.

While this invention has been described with respect to various specific examples and embodiments, it is to be understood that the invention is not limited thereto and that it can be variously practiced with the scope of the following claims.

What is claimed is:

1. A method for coating a lens, the method comprises the steps of:
coating at least a portion of a surface of a lens comprising a lens polymer component with (i) a binder component comprising a binding polymer component having at least one epoxy group per polymer molecule, and (ii) an activation component effective to crosslink the binding polymer component; and
causing the activation component to react with the binder component, thereby forming a coating comprising a crosslinked polymer component.

2. The method of claim 1 wherein the binding polymer component includes polymer molecules including two or more epoxy groups.

3. The method of claim 1, wherein the crosslinked polymer component is substantially free of covalent bonds with the lens polymer component.

4. The method of claim 1 wherein the lens polymer component is substantially free of functional groups effective to chemically react with the binding polymer component or with the activation component.

5. The method of claim 4 wherein the lens is substantially free of functional groups selected from the class consisting of —COOH, —NH—R, NCO and epoxy.

6. The method of claim 1 wherein the lens is a contact lens.

7. The method of claim 1 wherein the lens polymer component comprises a hydrophilic polymeric material.

8. The method of claim 1 wherein the lens polymer component comprises a polymeric material including units from at least one monomeric component selected from the group consisting of hydroxyalkyl methacrylates, methacrylic acid, N-vinylpyrrolidone, acrylamide, alkyl acrylamides, vinyl alcohol, silicon-containing monomers for polymerization into hydrophilic silicone polymers, siloxanes, silicon-containing acrylates, silicon-containing methacrylates and mixtures thereof.

9. The method of claim 1 wherein the binding polymer component comprises at least one of a co-polymer and a homo-polymer.

10. The method of claim 1 wherein the binding polymer component includes units from at least one hydrophilic monomeric component selected from the group consisting of hydrophilic N-vinyl heterocyclic monomers; hydrophilic C₁ to C₆ vinyl ethers; hydrophilic C₁ to C₆ esters of acrylic acid; hydrophilic C₁ to C₆ esters of methacrylic acid; hydrophilic vinyl monomers; hydrophilic diene monomers; hydrophilic C₁ to C₆ alkoxy C₁ to C₆ alkyl esters of acrylic, hydrophilic C₁ to C₆ alkoxy C₁ to C₆ alkyl esters of methacrylic acid and mixtures thereof.

11. The method of claim 1 wherein the binding polymer component includes units from hydroxyethyl methacrylate.

12. The method of claim 1 wherein the at least one epoxy group is provided by an epoxy-containing monomeric component selected from the group consisting of epoxy-containing ethylenically unsaturated compounds and mixtures thereof.

13. The method of claim 1 wherein the coating is a clear coating or a colored coating.

14. The method of claim 1 wherein the binder component further comprises a color component.

15. The method of claim 14 wherein the color component comprises a pigment and a liquid medium.

16. The method of claim 1 wherein the activation component comprises a compound including at least two functional groups and being free of —NCO and epoxy groups effective to react with the lens polymer component or the binding polymer component during the causing step.

17. The method of claim 1 wherein the activation component comprises a material selected from the group consisting of polyfunctional amines, polyfunctional acids, anhydrides, polyfuntional mercaptans, polyamides, melamine-formaldehyde compounds, urea-formaldehyde compounds, phenol-formaldehyde compounds and mixtures thereof.

18. The method of claim 1 wherein the activation component comprises a polyfunctional amine.

19. The method of claim 1 wherein the activation component comprises a compound including at least two —NH—R groups, wherein R is independently selected from the group consisting of hydrogen and C₁ to C₈ alkyl.

20. A coating composition for coating a lens comprising:
a binder component comprising a binding polymer component having at least one epoxy group per polymer molecule; and
an activation component effective to react with the binding polymer component to form a crosslinked polymer component.

21. The coating composition of claim 20 wherein the binding polymer component includes polymer molecules including two or more epoxy groups.

22. The coating composition of claim 20 useful to coat a lens comprising a lens polymer component substantially free of functional groups effective to chemically react with the binding polymer component or with the activation component.

23. The coating composition of claim 20 useful to form a coating on a lens comprising a lens polymer component without being covalently bonded to the lens polymer component.

24. The coating composition of claim 20 wherein the binding polymer component is derived from at least one monomeric unit component selected from the group consisting of hydrophilic N-vinyl heterocyclic monomers; hydrophilic C₁ to C₆ vinyl ethers; hydrophilic C₁ to C₆ esters of acrylic acid, hydrophilic C₁ to C₆ esters of methacrylic acid; hydrophilic vinyl monomers; hydrophilic diene monomers; hydrophilic C₁ to C₆ alkoxy C₁ to C₆ alkyl esters of acrylic acid; hydrophilic C₁ to C₆ alkoxy C₁ to C₆ alkyl esters of methacrylic acid; and mixtures thereof.

25. The coating composition of claim 20 wherein the at least one epoxy group is provided by an epoxy-containing monomeric component selected from the group consisting of epoxy-containing ethylenically unsaturated compounds and mixtures thereof.

26. The coating composition of claim 20 which is substantially free of a color component, and is effective to provide a substantially optically clear coating on a lens.

27. The coating composition of claim 20 wherein the binder component further comprises an effective amount of a color component.

28. The coating composition of claim 27 wherein the color component comprises a pigment and a liquid medium.

29. The coating composition of claim 20 wherein the activation component comprises a compound including at least two functional groups and being free of —NCO and epoxy groups.

30. The coating composition of claim 20 wherein the activation component comprises a material selected from the group consisting of polyfunctional amines, polyfunctional acids, anhydrides, polyfuntional mercaptans, polyamides, melamine-formaldehyde compounds, urea-formaldehyde compounds, phenol-formaldehyde compounds and mixtures thereof.

31. The coating composition of claim 20 wherein the activation component comprises a polyfunctional amine containing 2 to about 10 carbon atoms per molecule.

32. A coated lens comprising:
a lens body comprising a lens polymer component having a surface; and
a coating comprising a crosslinked polymer component located on at least a portion of the surface, the coating being derived from a coating composition comprising a binder component comprising a binding polymer component having at least one epoxy group, and an activation component effective to react with the binder polymer component to form the crosslinked polymer component.

33. The coated lens of claim 32 wherein the binding polymer component includes polymer molecules including two or more epoxy groups.

34. The coated lens of claim 32 which is a coated contact lens.

35. The coated lens of claim 32 wherein the crosslinked polymer component is substantially free of covalent bonds with the lens polymer component.

36. The coated lens of claim 32 wherein the lens polymer component is substantially free of functional groups effective to chemically react with the binding polymer component or with the activation component.

37. The coated lens of claim 36 wherein the lens polymer component is substantially free of functional groups selected from the class consisting of —COOH, —NH—R, NCO and epoxy.

38. The coated lens of claim 32 wherein the lens polymer component comprises a hydrophilic polymeric material.

39. The coated lens of claim 32 wherein the lens polymer component comprises a polymeric material including units from at least one monomeric component selected from the group consisting of hydroxyalkyl methacrylates, methacrylic acid, N-vinylpyrrolidone, acrylamide, alkyl acrylamides, vinyl alcohol, silicon-containing monomers useful for polymerization into hydrophilic silicone polymers, siloxanes, silicon-containing acrylates, silicon-containing methacrylates and mixtures thereof.

40. The coated lens of claim 32 wherein the polymer component is derived from at least one monomeric unit component selected from the group consisting of hydrophilic N-vinyl heterocyclic monomers; hydrophilic C₁ to C₆ vinyl ethers; hydrophilic C₁ to C₆ esters of acrylic acid, hydrophilic C₁ to C₆ esters of metacrylic acid; hydrophilic vinyl monomers; hydrophilic diene monomers; hydrophilic C₁ to C₆ alkoxy C₁ to C₆ alkyl esters of acrylic acid; hydrophilic C₁ to C₆ alkoxy C₁ to C₆ alkyl esters of methacrylic acid; and mixtures thereof.

41. The coated lens of claim 32 wherein the at least one epoxy group is provided by an epoxy-containing monomeric component selected from the group consisting of epoxy-containing ethylenically unsaturated compounds and mixtures thereof.

42. The coated lens of claim 32, wherein the coating is a clear coating or a colored coating.

43. The coated lens of claim 32 wherein the binder component further comprises an effective amount of a color component.

44. The coated lens of claim 43 wherein the color component comprises a pigment and a liquid medium.

45. The coated lens of claim 32 wherein the activation component comprises a compound including at least two functional groups and being free of —NCO and epoxy groups.

46. The coated lens of claim 32 wherein the activation component comprises a material selected from the group consisting of polyfunctional amines, polyfunctional acids, anhydrides, polyfuntional mercaptans, polyamides, melamine-formaldehyde compounds, urea-formaldehyde compounds, phenol-formaldehyde compounds and mixtures thereof.

47. The coated lens of claim 32 wherein the activation component comprises a polyfunctional amine.

48. The coated lens of claim 32 wherein the activation component comprises a polyfunctional amine containing 2 to about 10 carbon atoms per molecule.
